(19) United States
(12) Patent Application Publication
(10) Pub. No.: US 2013/0031129 A1
(43) Pub. Date: Jan. 31, 2013

(54) APPARATUS AND METHOD FOR EXTENDING A MODEL OF A SEMANTIC WEB APPLICATION, AND TERMINAL USING THE SAME

(71) Applicant: Tae-Ho Jang, Gunpo-si (KR)

(72) Inventor: Tae-Ho Jang, Gunpo-si (KR)

(21) Appl. No.: 13/295,920

(22) Filed: Nov. 14, 2011

(30) Foreign Application Priority Data
Jul. 25, 2011 (KR) 10-2011-0073553

(51) Int. Cl. G06F 7/00; G09G 5/00

(52) U.S. Cl. 707/769; 345/629

(57) ABSTRACT

A technique for extending a model of a semantic web application based on a model of a linked data set is provided. At least one linked data set related to the model of the semantic web application may be searched for, a model of the linked data set may be extracted, and information from the model of the linked data set may be added to the model of the semantic web application.

CROSS-REFERENCE TO RELATED APPLICATION(S) This application claims the benefit under 35 U.S.C. §119(a) of Korean Patent Application No. 10-2011-0073553, filed on Jul. 25, 2011, in the Korean Intellectual Property Office, the entire disclosure of which is incorporated herein by reference for all purposes.

### BACKGROUND

1. Field

The following description relates to a technique for searching for a linked data set that is related to user context information and extending a model of a semantic web application using a model of a found linked data set.

2. Description of the Related Art

The semantic web is defined as a gigantic space of data in which machines can understand and process the meaning of information on the World Wide Web. The semantic web allows machines to understand information similar to how humans understand information. The semantic web refers to a web which defines meanings of resources and relations between the resources in a linguistic expression. The semantic web allows a machine to logically analyze data based on the defined meanings of the resources.

Linked data may be generated by specifying relationships between raw data on the semantic web. Linked data is an example of a method of publishing structured data so that it can be interlinked and become more useful. Linked data builds upon standard Web technologies such as HTTP and URIs, but rather than using them to serve web pages for human readers, it extends them to share information in a way that can be read automatically by computers and other various machines. The linked data may be stored in a storage unit of an external server and/or a terminal. Due to the rapid increase in linked data, various applications have been developed for the purpose of utilizing the linked data.

However, it is difficult and complicated to retrieve a large amount of linked data for a particular application. Thus, there is a need for a faster and easier method for collecting linked data.

### SUMMARY

In one general aspect, there is provided an apparatus for extending a model of a semantic web application, including: a search unit configured to search for at least one linked data set that is related to the model of the semantic web application; a first model extracting unit configured to extract a model of the found linked data set, wherein the model includes at least one class; and an adding unit configured to add information from the model of the found linked data set to the model of the semantic web application.

The apparatus may further include a second model extracting unit configured to extract a model of a semantic web application corresponding to user context information, wherein the extracted model includes at least one class.

The search unit may be further configured to search for the linked data set based on a type of the class included in the semantic web application and a property of the class.

The search unit may be further configured to search for the linked data set using a linked data endpoint that is an interface which is accessible to data represented in a semantic web format (Resource Description Format; RDF).

The adding unit may be further configured to add the class included in the model of the linked data set and data associated with the class to the model of the semantic web application.

The adding unit may be further configured to generate a query using the user context information and linked data that belongs to the linked data set, and execute the generated query to obtain data that is associated with the class included in the linked data set.

The first model extracting unit may be further configured to extract only the class from the linked data set and generate a model of the linked data set by using the extracted class, in response to a schema of the linked data set not being found.

The adding unit may be further configured to map the model of the semantic web application and the model of the linked data set to determine whether there is a relationship between the model of the semantic web application and the model of the linked data set, and, in response to there being a relationship between the model of the semantic web application and the model of the linked data set, add a class included in the model of the linked data set and data associated with the class to the model of the semantic web application.

The linked data set may include at least one piece of linked data, the linked data may be generated by specifying relationships between raw data, and the class may indicate a concept based on which data having the same properties are classified into the same group.

In another aspect, there is provided a method of extending a model of a semantic web application, including: searching for at least one linked data set that is related to the model of the semantic web application; extracting a model of the found linked data set wherein the model includes at least one class; and adding information from the model of the found linked data set to the model of the semantic web application.

The method may further include extracting a model of a semantic web application corresponding to user context information wherein the extracted model includes at least one class.

The searching may include searching for the linked data set based on a type of the class included in the semantic web application and a property of the class.

The searching may include searching for the linked data set using a linked data endpoint that is an interface which is accessible to data represented in a semantic web format (Resource Description Format; RDF).

The adding may include adding the class included in the model of the linked data set and data associated with the class to the model of the semantic web application.

The adding may include generating a query using the user context information and linked data that belongs to the linked data set, and executing the generated query to obtain data that is associated with the class included in the linked data set.

The extracting may include generating a model of the linked data set using the class included in the linked data set, in response to a schema of the linked data set not being found.

The method may further include mapping the model of the semantic web application and the model of the linked data set to determine whether there is a relationship between the model of the semantic web application and the model of the linked data set.

The adding may include adding a class included in the model of the linked data set and data associated with the class to the model of the semantic web application, in response to determining that there is a relationship between the model of the semantic web application and the model of the linked data set.

The linked data set may include at least one piece of linked data, the linked data may be generated by specifying relationships between raw data, and the class may indicate a concept based on which data having the same properties are classified into the same group.

In another aspect, there is provided a terminal including: a display unit configured to display a class included in a model of a semantic web application; a semantic web application model extending unit configured to add a class that is included in a model of at least one linked data set that is related to the model of the semantic web application, and to add data associated with the class to the model of the semantic web application; and a control unit configured to control the display unit to further display the added class and the data associated with the added class.

Other features and aspects may be apparent from the following detailed description, the drawings, and the claims.

### BRIEF DESCRIPTION OF THE DRAWINGS

FIG. 1 is a diagram illustrating an example of an apparatus for extending a model of a semantic web application.

FIG. 2 is a diagram illustrating another example of an apparatus for extending a model of a semantic web application.

FIG. 3 is a diagram illustrating an example of an apparatus for extending a model of a semantic web application determining a relationship between models.

FIGS. 4 and 5 are diagrams illustrating examples of an application for extending a model of a semantic web application.

FIG. 6 is a diagram illustrating an example of providing information to a user based on the extended model of the semantic web application.

FIG. 7 is a flowchart illustrating an example of a method of extending a model of a semantic web application.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

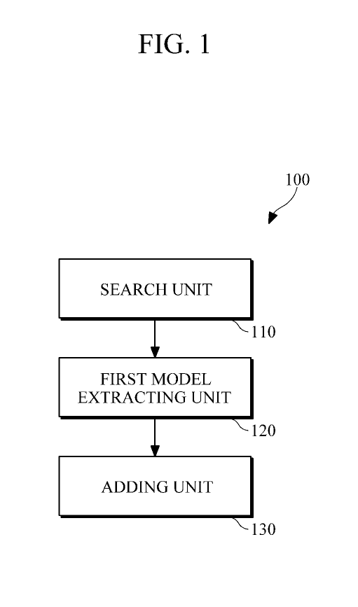

FIG. 1 illustrates an example of an apparatus for extending a model of a semantic web application.

Referring to FIG. 1, an apparatus 100 for extending a model of a semantic web application (“apparatus”) includes a search unit 110, a first model extracting unit 120, and an adding unit 130.

For example, the apparatus 100 may be included in a terminal. The terminal may be a mobile phone, a smart phone, a notebook computer, a digital media broadcasting terminal, a personal digital assistant (PDA), a portable multimedia player (PMP), a navigation device, a personal computer, a tablet, and the like, which can store and execute an application.

The search unit 110 may search for at least one linked data set that is related to a model of a semantic web application. The model may include at least one class. A class included in the model may be categorized into a superclass and a subclass. The class indicates a concept in which data that has the same properties may be classified into the same group. Each class may have a uniform resource identifier (URI).

The linked data set may include at least one piece of linked data. The linked data may be generated by defining meaningful relationships between raw data. For example, in a semantic web technology, resource description format (RDF) may be utilized to represent raw data on a web. According to RDF, raw data may be represented in a triple format of <Subject, Predicate, Object>. All linked data can be represented in a triple format. For example, Subject may indicate a class, and Object may indicate a class or data.

The semantic web application may be installed in a user's terminal, and the linked data set may be stored in a storage unit (not illustrated) included in an external server or a terminal such as the user's terminal. For example, the storage unit may be at least one of a RAM, a ROM, a flash memory, a hard disk type memory, a multimedia card micro type memory, a card type memory, and the like.

In one example, the search unit 110 may search for the linked data set based on a type and a property of the class which is included in the model of the semantic web application. For example, the property of the class may indicate a relationship between classes and/or a relationship between each class and data in the model.

In another example, the search unit 110 may detect a linked data endpoint based on the type and the property of the class included in the model of the semantic web application. The linked data endpoint indicates an interface that is accessible to linked data and that is represented in a semantic web format (RDF) or the linked data set. For example, the linked data endpoint may retrieve a data set, data, and the like, which may be represented in a variety of formats, such as JSON, SML, RDF, and the like, in response to a query. The search unit 110 may execute the query through the detected data end point to search for the linked data set.

The first model extracting unit 120 may extract a model of the linked data set. For example, the model of the linked data set may include at least one class. If a schema of the linked data set is not found, the first model extracting unit 120 may only extract a class from the linked data set and generate a model of the linked data set. In a case in which the information about the linked data set is not stored in the storage unit (not illustrated) nor available publicly, the first model extracting unit 120 is not able to search for information about the model of the linked data set. In contrast, if the information about the model of the linked data set is found, the first model extracting unit 120 may extract a model of the linked data set based on the found model.

The adding unit 130 may add data from the model of the linked data set to the model of the semantic web application. For example, the adding unit 130 may add a class that is included in the model of the linked data set and data that is associated with the class to the model of the semantic web application, thereby extending the model of the semantic web application.

The adding unit 130 may make a query using user context information and the linked data belonging to the linked data set. For example, if the user context information is “the user watches the movie The Mission” and the linked data may include “John is the director of The Mission.” In this example, the adding unit 130 may generate queries about the director, the cast of the movie, the filming location, and the like. For example, the queries may include “Who is the director?”, “Who is starring?”, “Where was the movie filmed?” Here, the director and the cast may be represented as classes, and “John” may be data associated with the director class. The adding unit 130 may execute the generated query to obtain data that is associated with the class included in the linked data set.

The adding unit 130 may map the model of the semantic web application and the model of the linked data set to determine whether there is a relationship between the models of the semantic web application and the linked data set. For example, the adding unit 130 may compare a class included in the model of the semantic web application with a class included in the model of the linked data set. The adding unit 130 may determine that there is a relationship between the models based on the presence of classes being mapped to each other. If the adding unit 130 determines that there is a relationship between the model of the semantic web application and the model of the linked data set, the adding unit 130 may add a class and data included in the model of the linked data set to the model of the semantic web application. As another example, if the adding unit 130 determines that there is no relationship between the model of the semantic web application and the model of the linked data set, the adding unit 130 may not add the model of the linked data set to the model of the semantic web application. Accordingly, a model of an unnecessary linked data set is prevented from being added to the model of the semantic web application.

As described in various examples herein, the apparatus 100 may search for a linked data set that is related to the model of the semantic web application, and may add information from the model of the found linked data set to the model of the semantic web application, thereby automatically extending the model of the semantic web application. In addition, the apparatus 100 may automatically collect data related to the model of the semantic web application and add the collected data to the model of the semantic web application.

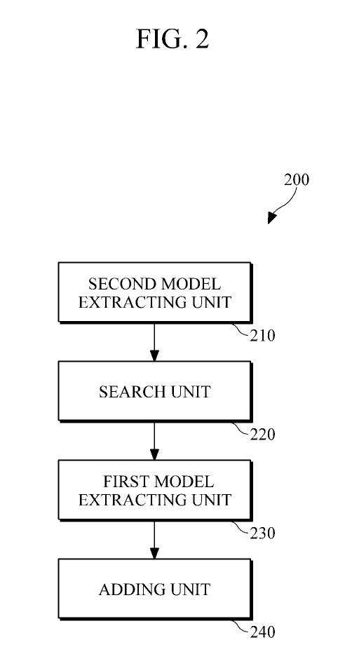

FIG. 2 illustrates another example of an apparatus for extending a model of a semantic web application.

Referring to FIG. 2, in this example apparatus 200 includes a second model extracting unit 210 in addition to a search unit 220, a first model extracting unit 230, and an adding unit 240.

The second model extracting unit 210 may extract a model of a semantic web application corresponding to user context information. For example, the user context information may indicate information about a user's situation, such as a user's current location, records of who a user calls, text messages which the user has sent and received, contents of emails, a user's propensity to consume, and the like. The user context information may be extracted from a device that can store or transmit and/or receive the user context information. For example, the user context information may be extracted from a position tracking device, an email server, a communication server, a terminal device, and the like.

For example, if the user of the semantic web application enters a theater, the second model extracting unit 210 may extract a model of a semantic web application related to movies. As another example, if the user of the semantic web application enters a baseball stadium, the second model extracting unit 210 may extract a model of a semantic web application related to baseball games. That is, the second model extracting unit 210 may extract a model of a semantic web application based on a user's situation.

The search unit 220 may search for at least one linked data set that is related to the model of the semantic web application extracted by the second model extracting unit 210.

The first model extracting unit 230 may extract a model of a linked data set, which includes at least one class.

The adding unit 240 may add information from the model of the linked data set to the model of the semantic web application. For example, the adding unit 240 may add the class included in the model of the linked data set and the data associated with the class to the model of the semantic web application, thereby extending the model of the semantic web application.

The apparatus 200 may extend a model of a semantic web application according to user context information, thereby dynamically extending the model of the semantic web application.

Additional descriptions of the search unit 220, the first model extracting unit 230, and the adding unit 240 are provided with reference to FIG. 1, and thus will not be reiterated.

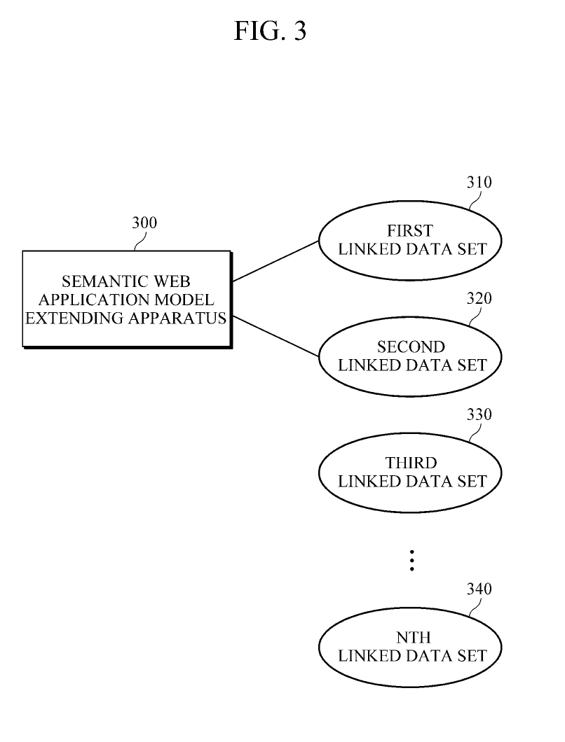

FIG. 3 illustrates an example of an apparatus for extending a model of a semantic web application determining a relationship between models.

Referring to FIG. 3, apparatus 300 for extending a model of a semantic web application may search for at least one linked data set 310, 320, 330, and 340 which is related to the model of the semantic web application. The apparatus 300 may extract a model of each of the found linked data sets 310, 320, 330, and 340.

The apparatus 300 may map the model of each of the linked data sets 310, 320, 330, and 340 and the model of the semantic web application to determine whether there is a relationship between any of the models of the linked data sets and the model of the semantic web application. If the apparatus 300 determines that there are relationships between the model of the semantic web application and the models of a first linked data set 310 and a second linked data set 320, the apparatus 300 may add information from only the models of the first linked data set 310 and the second linked data set 320 to the model of the semantic web application. In this example, the apparatus 300 does not add information from the models of a third linked data set 330 and an n^{th} linked data set 340 to the model of the semantic web application.

For example, the apparatus 300 may add classes included in the models of the first and second linked data sets 310 and 320 and data that is associated with the classes to the model of the semantic web application, thereby extending the model of the semantic web application.

Because the apparatus 300 determines the relationship between model of the linked data set and the model of the semantic web application based on mapping results, only data from the relevant models of linked data sets may be added to the model of the semantic web application.

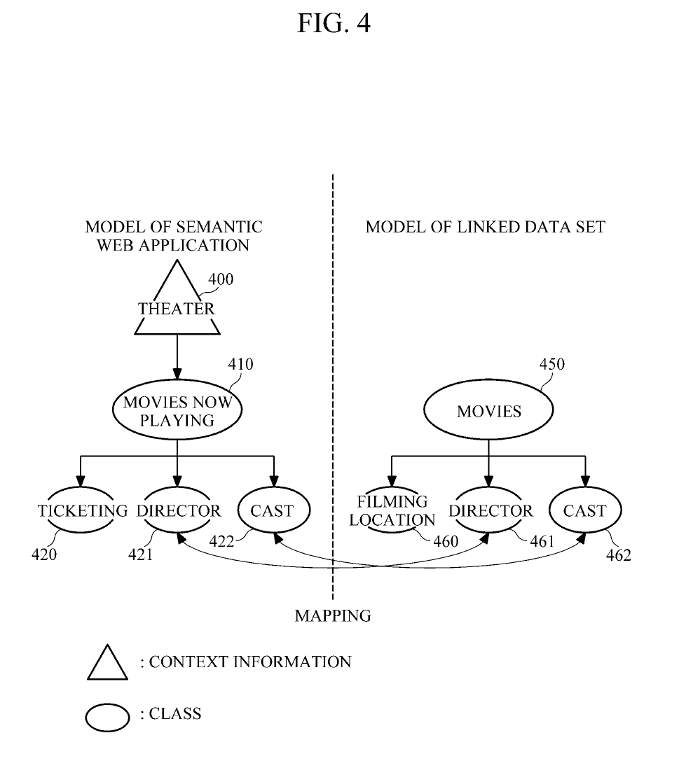

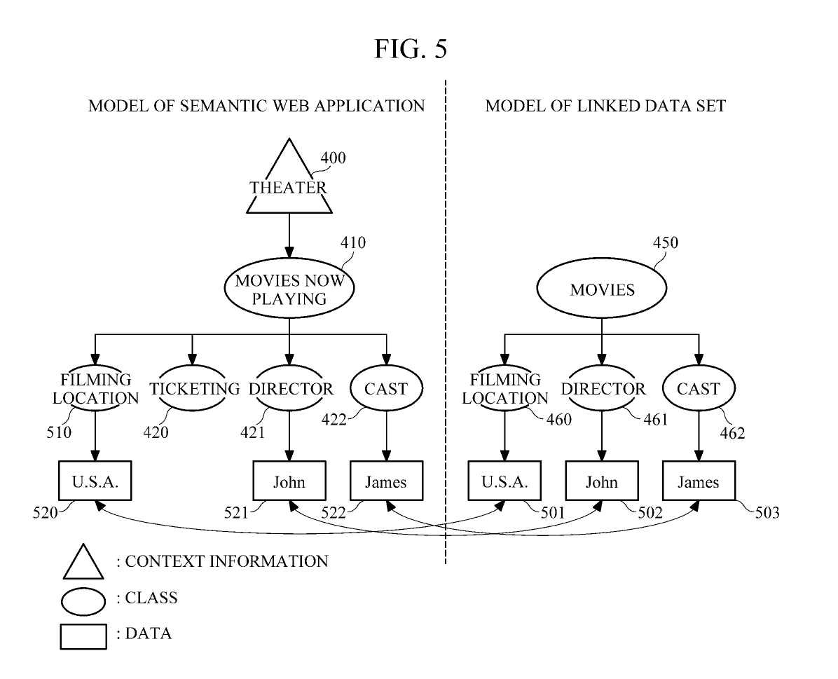

FIGS. 4 and 5 illustrate examples of an application for extending a model of a semantic web application. In the examples of FIGS. 4 and 5, classes included in the model are shown as a graph.

Hereinafter, for purpose of example the user context information is provided under the assumption that a user is placed in a theater, but examples herein are not limited to a theater.

Referring to FIG. 4, the apparatus may extract a model of a semantic web application related to a movie that corresponds to the user context information (“theater”) 400. In this example, the extracted model of the semantic web application includes classes “movies now playing” 410, “ticketing” 420, “director” 421, and “cast” 422. The class “movies now playing” 410 is a superclass of the other classes “ticketing” 420, “director” 421, and “cast” 422.

The apparatus may search for at least one linked data set that is related to the extracted model of the semantic web application based on the user context information. An example of how to search for the linked data set is provided with reference to FIG. 3, and thus will not be reiterated. The apparatus may extract a model of a linked data set which includes at least one class. In this example, the model of the linked data set includes the classes “movies” 450, “filming location” 460, “director” 461, and “cast” 462. The class “movies” 450 is a superclass of the other classes “filming location” 460, “director” 461, and “cast” 462.

The apparatus may map the model of the semantic web application and a model of the found linked data set. For example, the apparatus may compare the classes included in the model of the semantic web application and the classes included in the model of the linked data set. Referring to FIG. 4, the classes “director” 421 and “cast” 422 are mapped to class “director” 461 and class “cast” 462 of the model of the linked data set. Accordingly, the apparatus determines that the model of the semantic web application has a relationship with the model of the found linked data set as a result of the overlapping classes.

Referring to FIG. 5, the apparatus adds the class included in the model of the linked data set and data associated with the class to the model of the semantic web application. For example, the apparatus may extract the class “filming location” 460 from the model of the linked data set, which is not included in the model of the semantic web application. The apparatus may add class “filming location” 510 that is the same as the class “filming location” 460 to the model of the semantic web application.

The apparatus may extract pieces of data 501, 502, and 503 that are associated with the classes “filming location” 460, “director” 461, and “cast” 462, respectively, from the model of the linked data set. First data 501 is “U.S.A,” second data 502 is “John,” and third data 503 is “James.” The apparatus may add the extracted data 501, 502, and 503 to the classes 510, 421, and 422 included in the model of the semantic web application, thereby generating new data 520, 521, and 522 in the model of the semantic web application.

That is, as shown in FIG. 5, the apparatus may add the classes included in the linked data set and data associated with the classes to the model of the semantic web application, thereby automatically extending the model of the semantic web application. Accordingly, the model of the semantic web application includes more classes and data, and thus can provide more information to the user of the semantic web application.

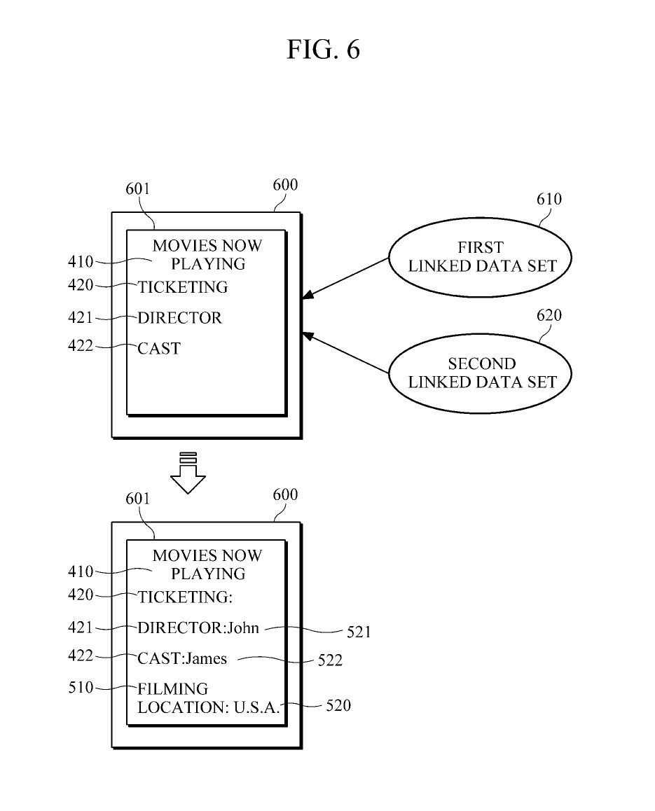

FIG. 6 illustrates an example of providing information to a user based on the extended model of the semantic web application.

Referring to FIGS. 4, 5, and 6, the apparatus for extending a model of a semantic apparatus may be included in a terminal 600. The apparatus may extract a model of a semantic web application corresponding to user context information (“the user is in a theater”). In this example, the model of the semantic web application includes classes “movies now playing” 410, “ticketing” 420, “director” 421, and “cast” 422. The class “movies now playing” 410 is a superclass of the other classes “ticketing” 420, “director” 421, and “cast” 422.

The apparatus may search for at least one linked data set such as linked data sets 610 and 620, each related to the extracted model of the semantic web application, based on the user context information. The apparatus may extract the model of each of the linked data sets 610 and 620, which each include at least one class.

Based on the class included in the linked data set, the apparatus may add class “filming location” 510 to the model of the semantic web application. The apparatus may extract pieces of data 501, 502, and 503 that are associated with the classes “filming location” 460, “director” 461, and “cast” 462 from the model of the linked data set. The apparatus may add pieces of data 520, 521, and 522 to the classes 510, 421, and 422 included in the model of the semantic web application based on the data associated with the classes included in the models of the linked data sets.

The apparatus may add the class 510 which was not previously included in the model of the semantic web application, and add the data 520, 521, and 522 which are associated with the classes 510, 421, and 422, respectively, thereby extending the model of the semantic web application. Thus, the apparatus is able to add the class 510 that was not previously included in the model of the semantic web application and provide the user of the terminal 600 with the data 520, 521, and 522 associated with the classes 510, 421, and 422.

The terminal 600 may display the classes 410, 420, 421, and 422 included in the model of the semantic web application using a display unit 601. The apparatus included in the terminal 600 may add the class 510 included in at least one linked data set and the data 520, 521, and 522 associated with the class 510 to the model of the semantic web application. For example, a control unit (not illustrated) of the terminal 600 may control the display unit 601 to further display the added class 510 and data 520, 521, and 522 associated with the class 510.

Accordingly, the apparatus may extend the model of the semantic web application based on the user context information, thereby dynamically extending the model and providing the user with the extended model of the semantic web application which is based on the user's situation. As a result, the user can obtain more information from the adaptively extended semantic web application than the existing general semantic web application.

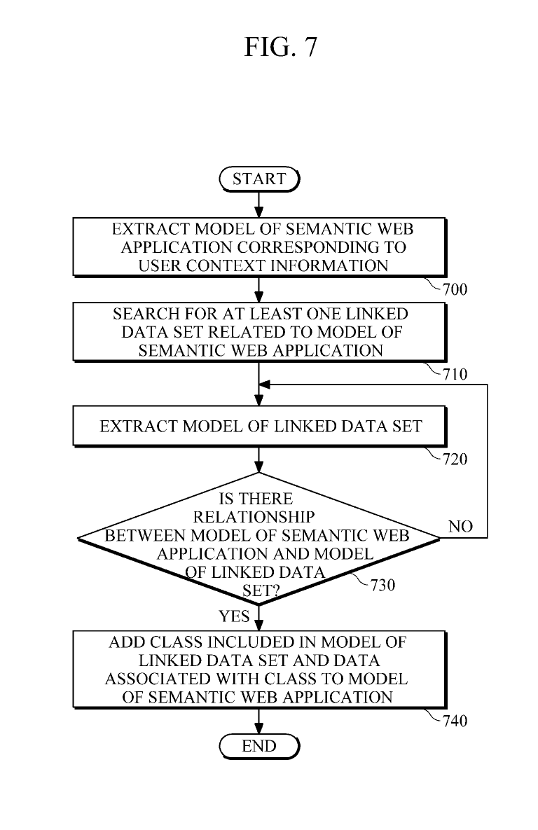

FIG. 7 illustrates an example of a method of extending a model of a semantic web application.

Referring to FIG. 7, a model of a semantic web application corresponding to user context information is extracted (700). At least one linked data set that is related to the model of the semantic web application is searched for (710). For example, the apparatus shown in FIG. 1 may search for the linked data set based on the type and the property of the class included in the model of the semantic web application. For example, the apparatus may search for the linked data set using a linked data endpoint that is accessible to data in a semantic web format (Resource Description Format; RDF).

A model of the linked data set, which includes at least one class is extracted (720). If there is no information about a model of the linked data set, the apparatus may generate a model of the found linked data set using the class included in the found linked data set.

The model of the semantic web application and the model of the linked data set are mapped to determine whether there is a relationship between the model of the semantic web application and the model of the linked data set (730).

If there is a relationship between the model of the semantic web application and the model of the linked data set, the class included in the model of the linked data set and data associated with the class to the model of the semantic web application are added to the semantic web application (740). For example, the apparatus may generate a query using the user context information and linked data belonging to the found linked data set, and execute the query to obtain data associated with the class of the found linked data set.

As another example, if there is no relationship between the model of the semantic web application and the model of the found linked data set, the apparatus may extract another model of the found linked data set (720). By repeating the above procedures, the apparatus is allowed to only add the model of the linked data set that is relevant to the model of the semantic web application.

As described in various examples, the method of extending a model of a semantic web application may search for a linked data set related to a model of a semantic web application, and add the model of the found linked data set to the model of the semantic web application, thereby automatically extending the model of the semantic web application.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for extending a model of a semantic web application, the apparatus comprising:
a search unit configured to search for at least one linked data set that is related to the model of the semantic web application;
a first model extracting unit configured to extract a model of a found linked data set, wherein the model comprises at least one class; and
an adding unit configured to add information from the model of the found linked data set to the model of the semantic web application.

2. The apparatus of claim 1, further comprising:
a second model extracting unit configured to extract a model of a semantic web application corresponding to user context information, wherein the extracted model comprises at least one class.

3. The apparatus of claim 1, wherein the search unit is further configured to search for the linked data set based on a type of the class included in the semantic web application and a property of the class.

4. The apparatus of claim 1, wherein the search unit is further configured to search for the linked data set using a linked data endpoint that is an interface which is accessible to data represented in a semantic web format (Resource Description Format; RDF).

5. The apparatus of claim 1, wherein the adding unit is further configured to add the class included in the model of the linked data set and data associated with the class to the model of the semantic web application.

6. The apparatus of claim 2, wherein the adding unit is further configured to generate a query using the user context information and linked data that belongs to the linked data set, and execute the generated query to obtain data that is associated with the class included in the linked data set.

7. The apparatus of claim 1, wherein the first model extracting unit is further configured to extract only the class from the linked data set and generate a model of the linked data set by using the extracted class, in response to a schema of the linked data set not being found.

8. The apparatus of claim 1, wherein the adding unit is further configured to map the model of the semantic web application and the model of the linked data set to determine whether there is a relationship between the model of the semantic web application and the model of the linked data set, and, in response to there being a relationship between the model of the semantic web application and the model of the linked data set, to add a class included in the model of the linked data set and data associated with the class to the model of the semantic web application.

9. The apparatus of claim 1, wherein the linked data set comprises at least one piece of linked data, the linked data is generated by specifying relationships between raw data, and the class indicates a concept based on which data having the same properties are classified into the same group.

10. A method of extending a model of a semantic web application, the method comprising:
searching for at least one linked data set that is related to the model of the semantic web application;
extracting a model of a found linked data set, wherein the model comprises at least one class; and
adding information from the model of the found linked data set to the model of the semantic web application.

11. The method of claim 10, further comprising:
extracting a model of a semantic web application corresponding to user context information, wherein the extracted model comprises at least one class.

12. The method of claim 10, wherein the searching comprises searching for the linked data set based on a type of the class included in the semantic web application and a property of the class.

13. The method of claim 10, wherein the searching comprises searching for the linked data set using a linked data endpoint that is an interface which is accessible to data represented in a semantic web format (Resource Description Format; RDF).

14. The method of claim 10, wherein the adding comprises adding the class included in the model of the linked data set and data associated with the class to the model of the semantic web application.

15. The method of claim 11, wherein the adding comprises generating a query using the user context information and linked data that belongs to the linked data set, and executing the generated query to obtain data that is associated with the class included in the linked data set.

16. The method of claim 10, wherein the extracting comprises generating a model of the linked data set using the class included in the linked data set, in response to a schema of the linked data set not being found.

17. The method of claim 10, further comprising:
mapping the model of the semantic web application and the model of the linked data set to determine whether there is a relationship between the model of the semantic web application and the model of the linked data set.

18. The method of claim 17, wherein the adding comprises adding a class included in the model of the linked data set and data associated with the class to the model of the semantic web application, in response to determining that there is a relationship between the model of the semantic web application and the model of the linked data set.

19. The method of claim 10, wherein the linked data set comprises at least one piece of linked data, the linked data is generated by specifying relationships between raw data, and the class indicates a concept based on which data having the same properties are classified into the same group.

20. A terminal comprising:
a display unit configured to display a class included in a model of a semantic web application;
a semantic web application model extending unit configured to add a class that is included in a model of at least one linked data set that is related to the model of the semantic web application, and to add data associated with the class to the model of the semantic web application; and
a control unit configured to control the display unit to further display the added class and the data associated with the added class.
